(19) United States
(12) Patent Application Publication
(10) Pub. No.: US 2006/0218043 A1
(43) Pub. Date: Sep. 28, 2006

(54) Computer-based method and system for online restaurant ordering

(76) Inventors: Michael Rosenzweig, Mt. Lakes, NJ (US); G.R. Homa, Livingston, NJ (US); Peter G. Becan, Clifton, NJ (US)

Correspondence Address: OBER / KALER;c/o Royal W. Craig, 120 East Baltimore Street, Baltimore, MD, 21202, US

(21) Appl. No.: 11/338,419

(22) Filed: Jan. 24, 2006

Related U.S. Application Data
(60) Provisional application No. 60/646,307, filed on Jan. 24, 2005.

(51) Int. Cl. G06Q 30/00

(52) U.S. Cl. 705/15

(57) ABSTRACT

A web-based restaurant ordering method and system wherein the customer accesses the restaurant's own web-site, reads the online menu, and may make dining reservations or place an online order by clicking on the desired menu items, verifying the order, and automatically sending the order via facsimile. The system monitors the order to ensure that no order is lost. The customer can place the order in a few minutes and the order is always correct, and therefore, satisfying to the customer. Moreover, the restaurant receives consistent up-to-date orders and thus can save money while providing better customer service.

### CROSS-REFERENCE TO RELATED APPLICATIONS

The present application derives priority from provisional patent application No. 60/646,307, filed Jan. 24, 2005.

### BACKGROUND OF THE INVENTION

1. Field of the Invention

The present invention relates to a method for web-based restaurant ordering or other retail ordering, and more particularly, to a system and method for an application service provider (ASP) to offer restaurants an online web-input to facsimile/online/email/POS Interface-output ordering and reservation service for their patrons.

2. Description of the Background

Customers of restaurant services are diverse: they come in all ages and from all walks of life. Nevertheless, the restaurant business is extremely competitive and all customers demand quick, quality service and quality food. Restaurants that are unable to provide good food and timely quality service are destined for failure.

In today's fast-paced world, many people do not always have the time to cook at home nor the energy to dine out. Instead, they turn to carry-out restaurants. According to the National Restaurant Association, 58% of restaurant sales are carry out sales. To place a carry out order a customer will either telephone the restaurant and place an order for pick-up or delivery, or stop by the restaurant to place the order and wait for the food to be prepared. Both of these methods have their downsides. For example, customers often call in to restaurants with a menu in hand, but the menu is one that has been lying around the house for years and is incorrect and outdated. Some restaurants are noisy and there are often significant communication problems, first verbal with the customer and then the cook or chef must decipher the employee order-taker's handwriting. Resulting orders may not even turn out to be what the caller intended. On the restaurant side, the nature of a telephone call demands immediate attention and this is often frustrating for employees fielding many calls and trying to serve the orders at the same time. It is also frustrating for customers if they sense that they do not have the employees' undivided attention. In sum, telephone ordering between a customer and a restaurant can be a frustrating and error-prone process, one that is not good for business.

Of course, customers can physically go into the restaurant to place the carry-out order, but this wastes precious time. Moreover, this approach also relies on verbal communications between the customer and the employee, as well as the ability of the employee to correctly record the customer's order. There is a large margin for error and dissatisfaction throughout the process.

There have been many attempts at in-house ordering systems to reduce error. For example, many fast food restaurants have graphical cash registers with icon representations of food items (to avoid entry errors), these registers sending the order directly to the cooks (to avoid transcription errors). However, no such level of automation currently exists in the carry-out world, where the telephone is still the primary means of communication. This creates an opportunity for a third party service provider to improve efficiency.

There exists a clear need for a system and method for an application service provider (ASP) to offer restaurants an online web-input to facsimile-output ordering and reservation service for their patrons, which is more efficient and error-free than call-in ordering. The present invention is intended to fulfill this need by providing a web-based carry-out ordering method and system wherein the customer logs into the subscriber restaurant's own web-site, selects an online menu from the subscriber restaurant, views and clicks on their desired menu items to auto-fill a familiar order ticket for that restaurant, and then verifies and sends the carry-out order. The order is automatically transmitted to the restaurant via facsimile. Customers can place an online order in a few minutes and the order is always convenient and correct. Moreover, the restaurant receives consistent up-to-date orders from their immediate menu and can avoid mistakes and provide better customer service. The net result is more loyalty from existing customers, good word-of-mouth advertising, plus an online presence to attract new customers to the restaurant.

Several conventional online ordering methods exist. For example, one well-known method is a central delivery service that customers call. The delivery service calls in the order, picks it up and delivers it to the end customer. These services may bring in additional orders to the restaurant, but in the end the customer pays dearly for the service. Another known method is a simple web-advertisement by which a third party places the restaurant's menu and telephone number on a central website (along with many other restaurants). Restaurants do not appreciate this approach because they cannot promote the site as their own, and the customers are shown competing menus when they log into the website. While a customer may log into the website with the intent of ordering from one restaurant, they may end up ordering from another restaurant when presented with choices.

U.S. Pat. No. 6,356,874 to .O slashed.hrn shows a computer-based method and system for ordering services, such as hotel rooms, via a user terminal connected to a central data processing device. The user specifies a particular service, such as hotel room, and the available options are returned to the user. The user then makes a selection and is forwarded to the selected entity to order the service. This approach is an elaborate directory and is not well-suited for dining reservations and/or placing online orders with a particular restaurant. No prior method or system allows each individual restaurant to showcase their own unique website promoting that restaurant, with integral means for ordering or making dining reservations online, all without the need for the restaurants to buy or maintain a computer.

Therefore, it would be advantageous over the prior art to provide a web-based restaurant reservations and ordering method and system wherein the customer accesses the restaurant's individual web-site, reads/prints the online menus, and may make dining reservations or order from one of the menus by clicking on the desired menu items, which immediately creates an online guest check, verifies the order, and automatically sends the order via facsimile.

### SUMMARY OF THE INVENTION

Accordingly, it is an object of the present invention to provide a web-based restaurant ordering method and system suited for traditional carry-out restaurants that are unable or unwilling to invest in elaborate dedicated computers.

It is another object of the present invention to provide a web-based restaurant ordering method and system that is accessible via the restaurant's own website.

It is another object of the present invention to provide a web-based restaurant ordering method and system that incorporates a unique method for placing orders in contrast to the standard shopping cart method.

It is yet another object of the invention to provide restaurants the ability to view their orders online.

It is a further object of the invention to provide a web-based restaurant ordering method and system that is quick, simple, reliable, and convenient to use for customers and restaurants alike.

It is yet another object of the invention to provide a web-based carry-out restaurant method and system that provides flexibility in managing daily menu changes.

The above objects are accomplished by providing a web-based restaurant ordering method and system wherein customers access a restaurant's own web-site, read an online menu, place an online order (or make dining reservations) by simply clicking on the desired menu items, verify the order, and submit the order via facsimile. The system monitors the order to ensure that no order is lost. The customer can place the order in a few minutes and the order is always correct, and error-free. Moreover, the restaurant receives consistent up-to-date orders from their most current menu, and thus can save money while providing better customer service.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a flow diagram of the computer-based method and system for online restaurant ordering according to the present invention.

FIG. 2 is a diagram of the restaurant web design feature of the present invention.

FIG. 3 is a flow diagram of the customer website update of the computer-based method and system for online restaurant ordering according to the present invention.

FIG. 4 is a screen print of an exemplary restaurant website home page.

FIG. 5 is a screen print of an exemplary Tour screen.

FIG. 6 is a screen print of an exemplary Testimonial screen.

FIG. 7 is a screen print of an exemplary About Us screen.

FIG. 8 is a screen print of an exemplary reservation screen.

FIG. 9 is a screen print of an exemplary menu screen.

FIG. 10 is a screen print of an exemplary Choices Menu screen 23.

FIG. 11 is a screen print of an exemplary Virtual Guest Check screen 22.

FIG. 12 is a screen print of an exemplary Order Summary screen.

FIG. 13 is an exemplary facsimile order.

### DETAILED DESCRIPTION OF THE PREFERRED EMBODIMENTS

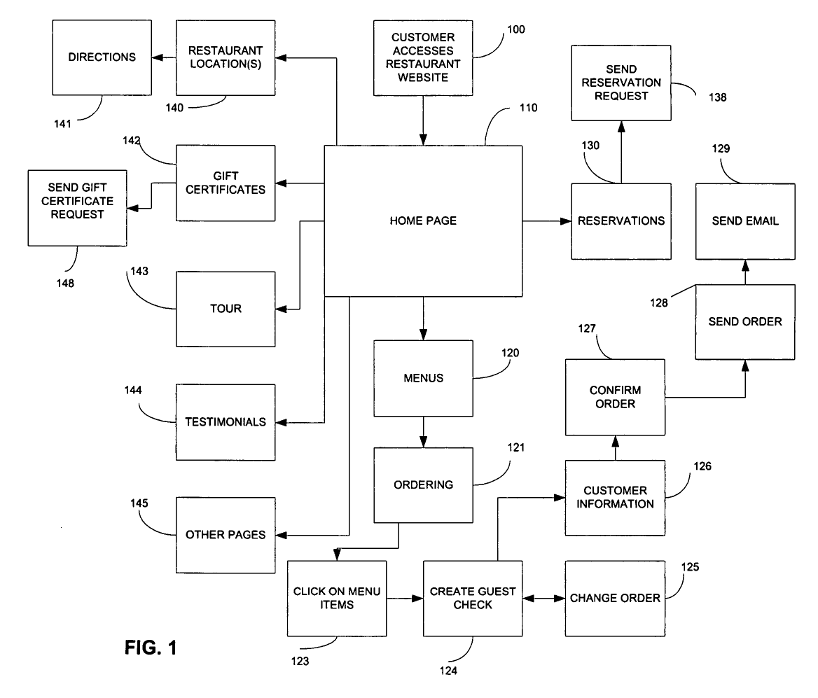

FIG. 1 is a flow diagram of the computer-based method and system for online restaurant ordering according to the present invention.

At Step 100, the customer accesses the restaurants' own website by any common access method, e.g., keying in a URL, selecting from search results, etc.

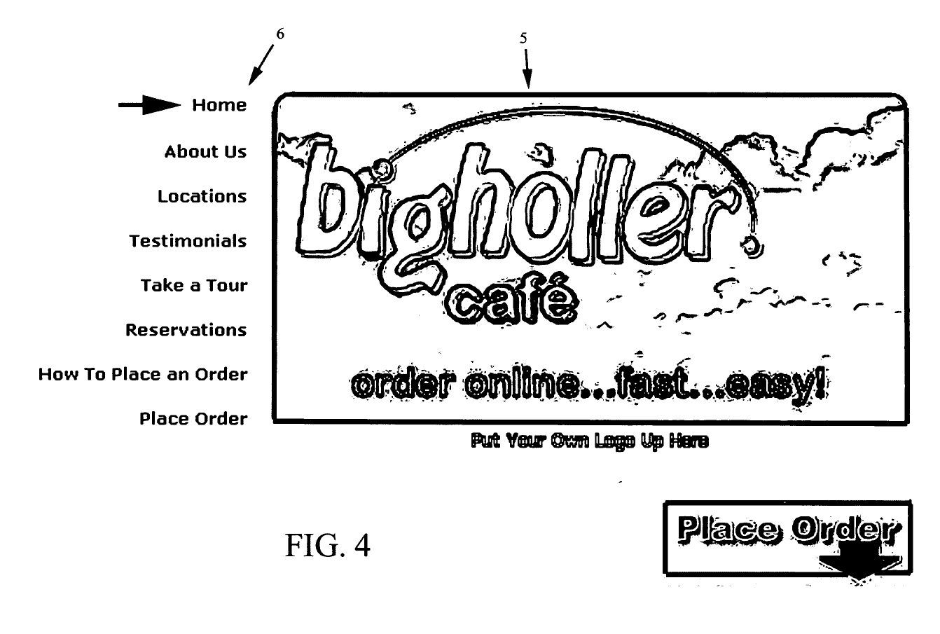

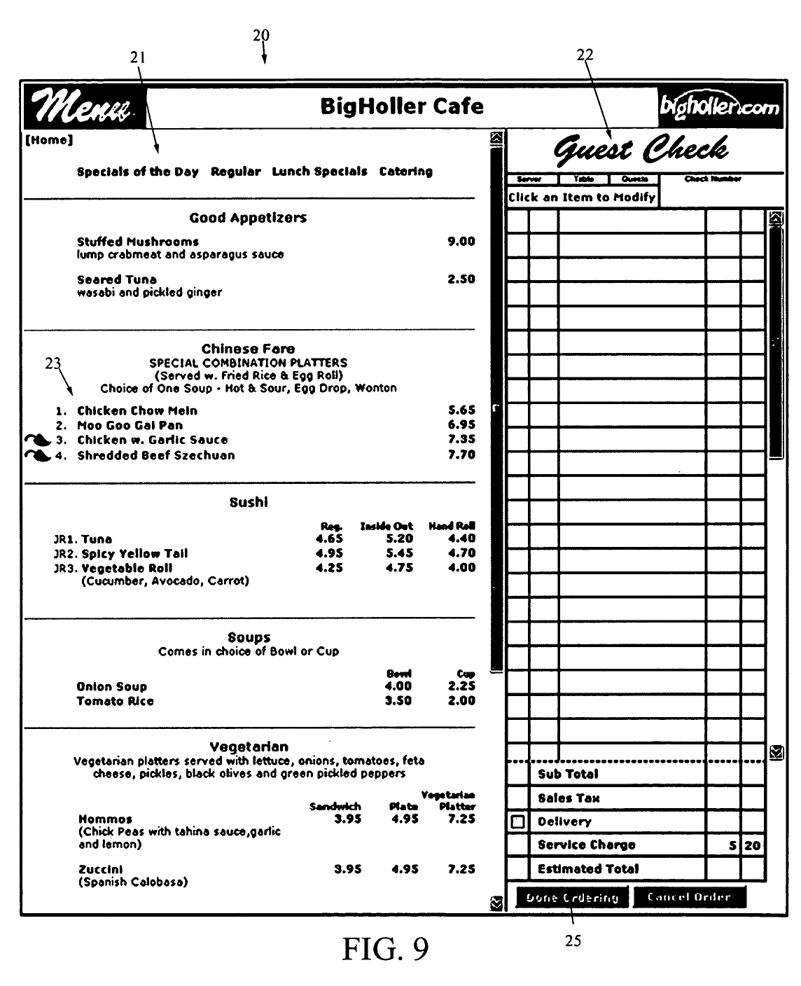

At Step 110, the customer is presented the restaurant's own home page 5. A screen print of an exemplary home page is shown in FIG. 4. From the home page 5, the user may select one of a plurality of tabs 6, including Home (the home page), About Us (description), Locations (for restaurant locations, see Step 140 of FIG. 1), Testimonials as at step 144, Take a Tour as at Step 143, Reservations as at Step 130, How to Order (Instructions), Online Ordering as at Step 120, or a variety of other value-added services such as Gift Certificates at Step 142 (link not shown in FIG. 4) or other Restaurant Flexible Page(s) at 145. All of these tabs 6 are available from the home page 5 as well as each of the other windows in the system, with the exception of the Online Ordering windows (to be described with reference to FIGS. 9-13).

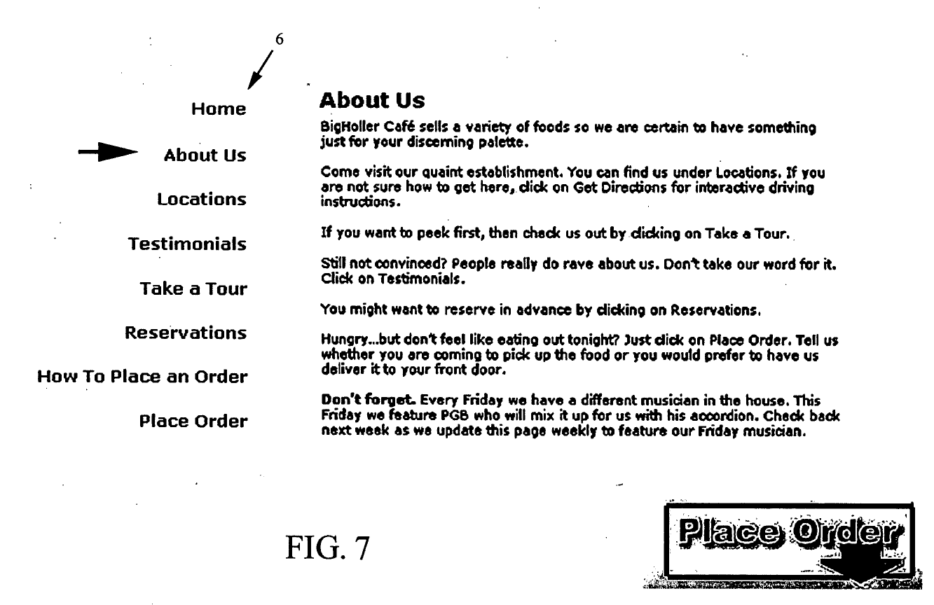

If the customer selects “About Us” a description window pops up as shown at FIG. 7.

If the customer selects Restaurant Locations at Step 140, a window with the restaurant's name, address, phone number, hours of operation and other identifying information is displayed with a “Get Directions” feature. The customer keys in their address or point of origin and directions to the restaurant are displayed.

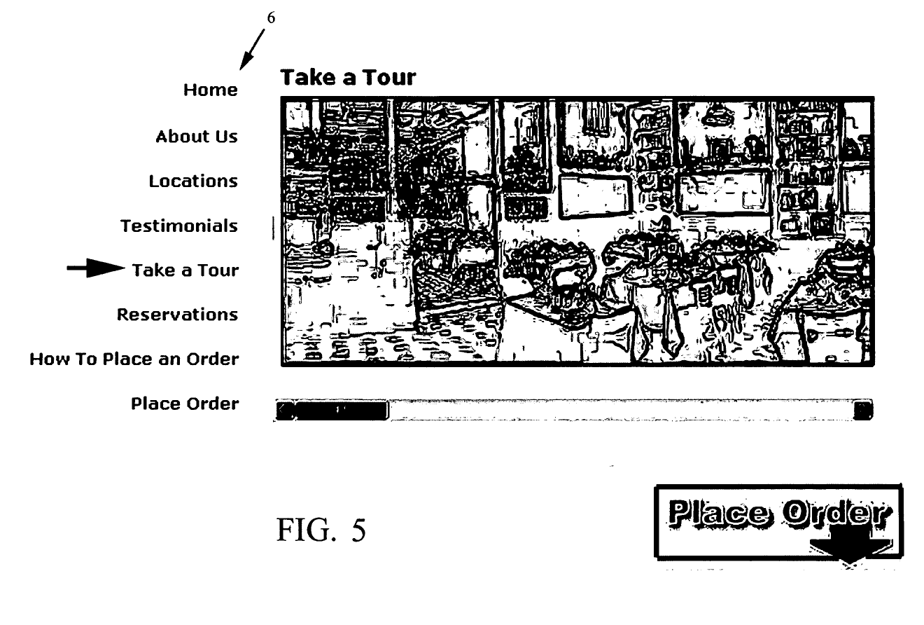

The customer may choose to go to Gift Certificates at Step 142, or to take a Tour at Step 143. The Gift Sets screen provides the capability to purchase restaurant gift certificates online. The customer keys in the necessary information to request the gift certificate and a facsimile of the request with a computer generated gift certificate number is transmitted to the restaurant. The Tour comprises photographs and/or a video of the restaurant and the dining experience, whatever photographs the restaurant chooses to display to promote their restaurant. A screen print of an exemplary Tour screen is shown in FIG. 5.

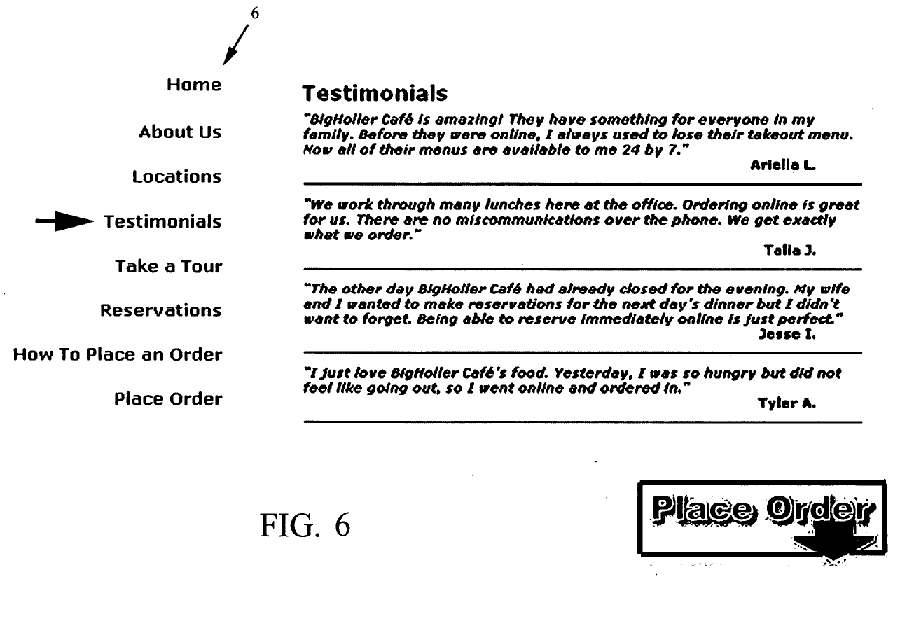

At Step 144, the customer can choose to view testimonials from satisfied customers. An exemplary Testimonial screen is shown in FIG. 6. If the restaurant has chosen to display other miscellaneous information, this is displayed at Step 145. This is one or more flexible screen(s) where the restaurant can display special events, information about the history of the restaurant, etc.

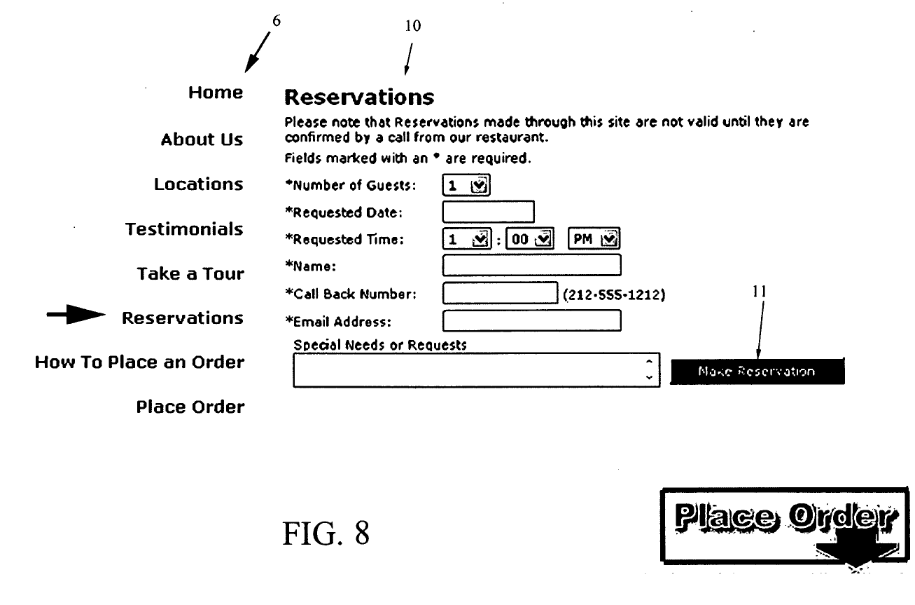

At Step 130, the customer may make dining reservations. A reservation input screen 10 is displayed. An exemplary reservation screen is shown in FIG. 8. The customer enters information, such as date, time, number of guests, call back number, and name, and clicks on the “Make Reservation” button 11. The customer can make the reservation at any time of day. The restaurant does not need to be open, so the customer does not need to wait for an inconvenient time to telephone the restaurant. When the customer clicks on the “Make Reservation” button 11, a facsimile of the reservation is transmitted to the restaurant. The reservation is confirmed by a telephone call from the restaurant to the customer.

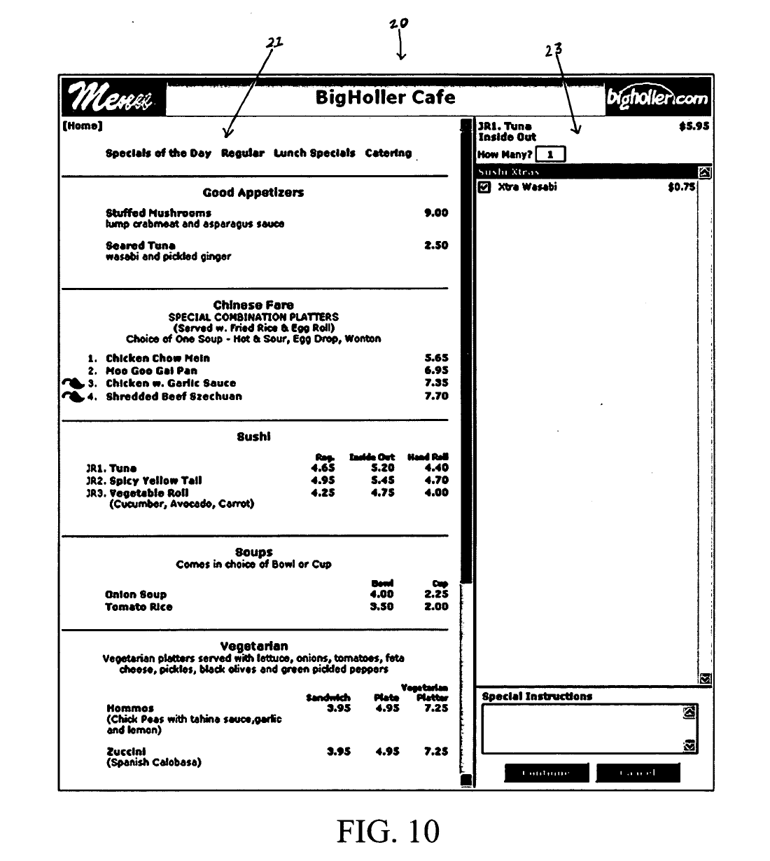

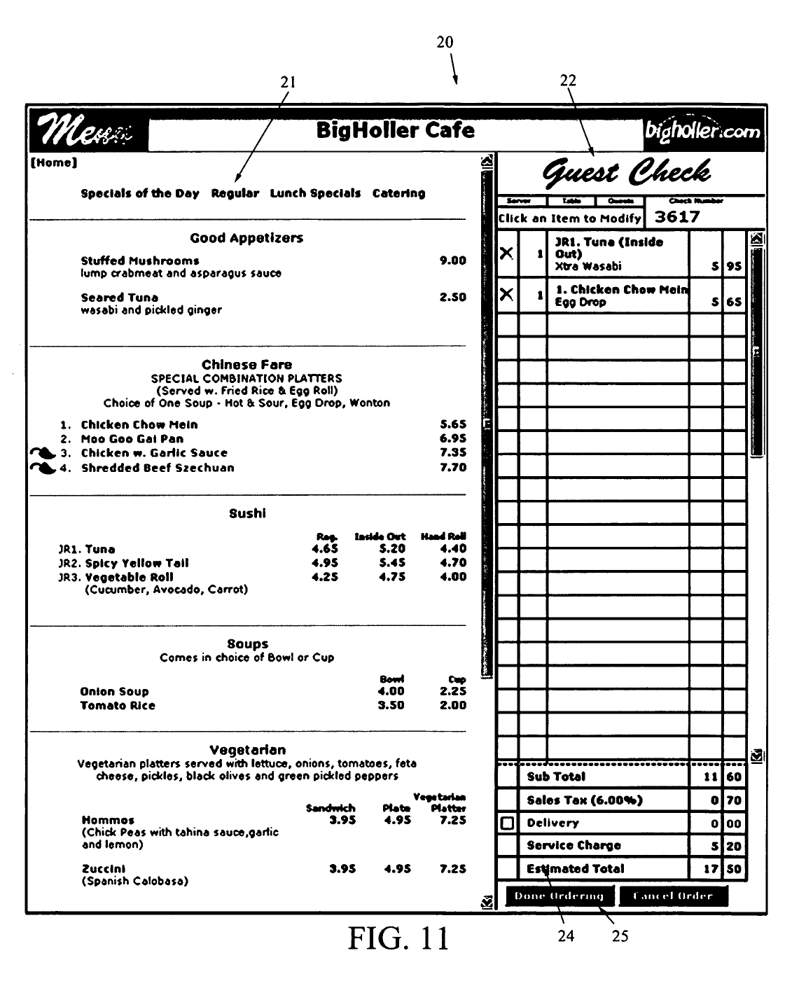

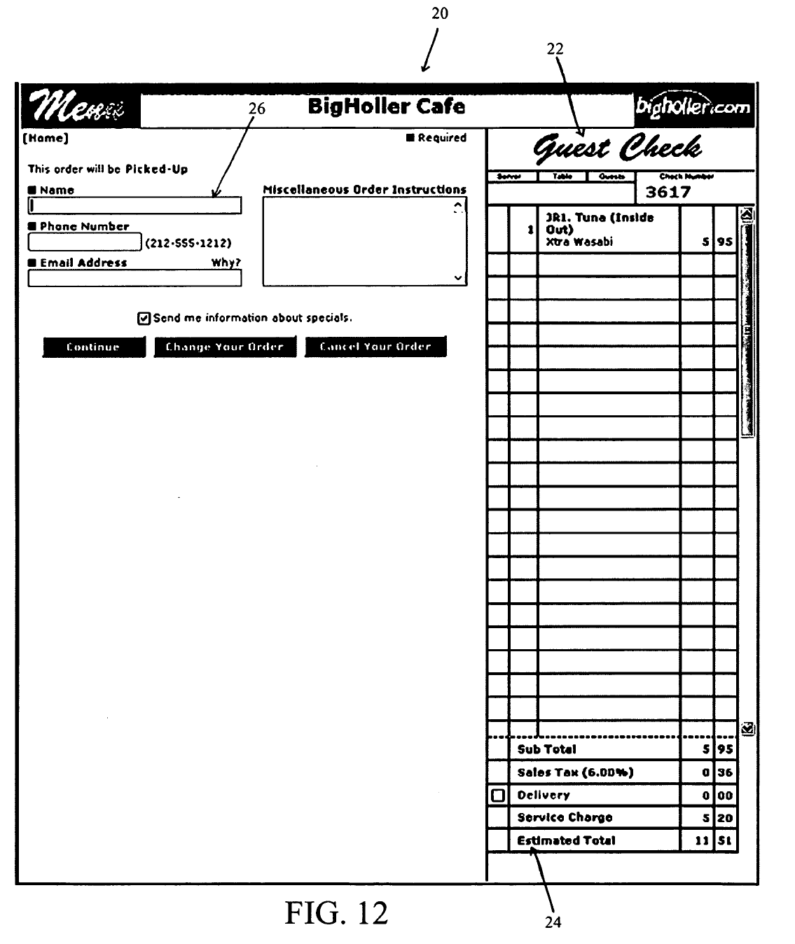

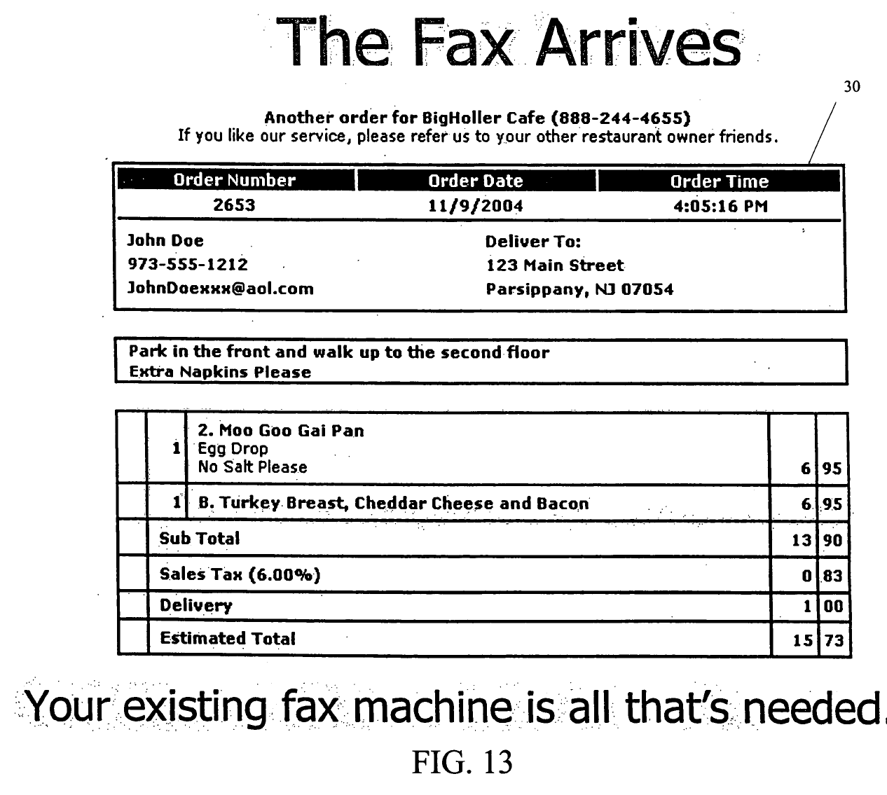

If the customer wishes to place an order, he or she clicks on the “Place Order” button and at Step 120 the restaurant's menu is displayed. The customer has the option to print the menu if desired. If the restaurant has more than one menu, e.g., lunch, dinner, etc., the customer selects the desired menu. The customer views the menu and at Step 121 begins the order process. An exemplary menu screen is shown in FIG. 9. The menu window 20 displays the menu 21 on the left and a “Virtual Guest Check” 22 on the right. The Virtual Guest Check 22 is a replica of and replaces the Waiter/Waitress paper pad. The customer clicks on the desired menu item at Step 123 and the item is immediately copied to the Virtual Guest Check 22 at Step 124. If a selected menu item has choices, e.g., type of soup that comes with lunch entree, the Virtual Guest Check 22 is temporarily replaced with a Choices Menu 23 and the customer makes the necessary choices and enters any special instructions. An exemplary Choices Menu screen 23 is shown at right in FIG. 10. Once choices are made the Virtual Guest Check 22 returns and is automatically totaled 24, including sales tax, as each menu item is selected. An exemplary Virtual Guest Check 22 screen is shown in FIG. 11 with totals. The customer specifies delivery if delivery is requested, otherwise, the order is prepared for pick-up. The customer may also request a specific delivery time, such as the next day. If the customer makes an error or wishes to remove items from the order, at Step 125, he or she changes the order. As changes are made, the Virtual Guest Check is recalculated. At any time, before sending the order, the customer can cancel the order (by the Cancel button at bottom right). When the customer has finished choosing the desired menu items, he or she clicks on the “Done Ordering” button 25 (bottom right) and another screen is displayed, which shows the Virtual Guest Check 22 on the right and customer information 26 on the left. An exemplary Order Summary screen is shown at FIG. 12. At Step 126, the customer enters name, address, phone number, and email address and payment information. The customer information 26 is stored for future orders. Any special order instructions may be entered at this window. For example, the customer may request extra ketchup, extra napkins, or provide delivery instructions. Once the customer information and special instructions are entered at Step 126, a Confirm Order window is displayed at Step 127. This window summarizes customer information, presents the totaled Virtual Guest Check, displays any optional messages desired by the restaurant, and present the customer with a “Confirm Order” button. Upon clicking the Confirm Order button, the system automatically validates the delivery time and customer zip code to ensure that the delivery time is within normal hours and the customer zip code is within the delivery area, and appropriate messages are displayed accordingly. The customer then verifies the order and customer information and clicks on the “Send Order” button at Step 128. When the customer clicks on the “Send Order” button, the order is automatically sent to the restaurant via facsimile transmission. The system automatically assigns an order number and generates a facsimile copy of the order 30 with the time and date, customer information, order, and any special instructions. An exemplary facsimile 30 is shown in FIG. 13. The facsimile 30 is transmitted to the restaurant's facsimile phone number and at Step 129 an electronic mail message is sent to the customer confirming that the facsimile 30 was sent. When the facsimile 30 is received by the restaurant, another email is sent from the restaurant to the customer confirming receipt. In the preferred embodiment the online ordering system is maintained by a third party application service provider (ASP) with live operators, and the ASP automatically monitors the transmission of the facsimile 30 and the restaurant confirmation and flags any inattention to the restaurant to ensure that orders are not lost. For example, if a facsimile transmission is delayed, an operator intervenes and phones the order to the restaurant.

Any participating restaurant may implement the foregoing online ordering system on their own pre-existing website simply by incorporating a link to the ASP Ordering Engine into their existing website either as an iframe or as a simple URL link. For restaurants that do not have an existing website, the ASP provides web design features to allow creation of a website, and customer website update features for updating menus, prices and other content.

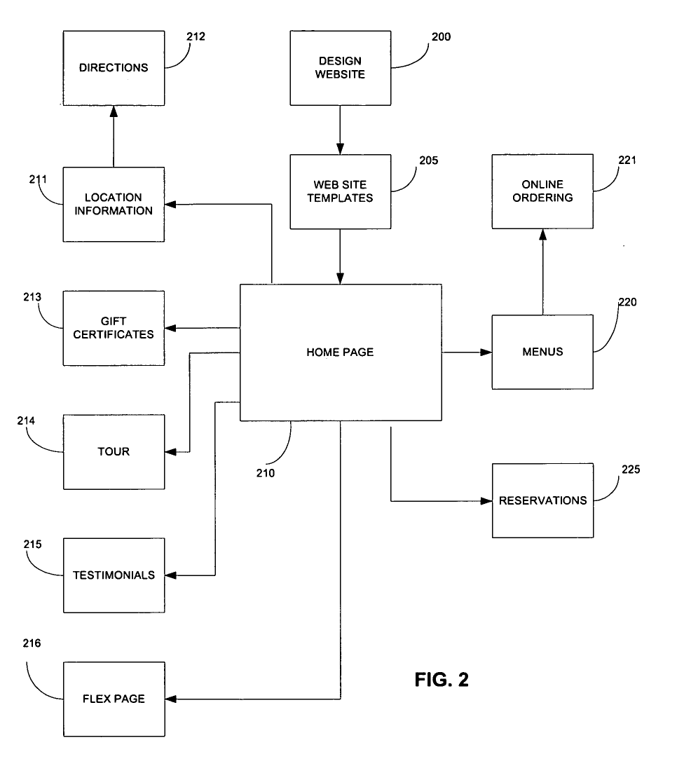

FIG. 2 is a diagram of the restaurant web design feature of the present invention. At Step 200, the process begins with a customer choosing the restaurant ordering quick and easy web design. At Step 205, web page templates are provided. These templates include home page, menus, etc. At Step 210 the restaurant home page 5 is designed from the home page template. The restaurant can choose a pre-existing banner associated with the type of restaurant, such as deli, pizzeria, etc., or the restaurant can omit the banner. Additionally, the restaurant may tailor the home page 5 with the restaurant logo, promotional material, or other text and/or graphics. At Step 211, the restaurant location is created for the location page, and Step 212 is the link to driving directions to the restaurant. At Step 213, gift certificates are established. At Step 214, photographs of the restaurant are imported for the Tour section. At Step 215, testimonials may be entered or imported. At Step 216, the optional flexible page is created. This page contains information such as “about us”, special events, etc. At Step 220, the restaurant's menu(s) are created. Menu items are defined by category, such as appetizer, entree, etc. and price structure, such as cup or bowl of soup, small or large salad, etc. Graphics may be inserted for borders, logos, photographs, etc. to create the look and feel that the restaurant wishes to convey. For example, menu graphic bullets may be inserted for particular menu items, such as to designate extra spicy. The online ordering feature 221 and the reservation feature are standard windows with the particular restaurant name shown in the banner.

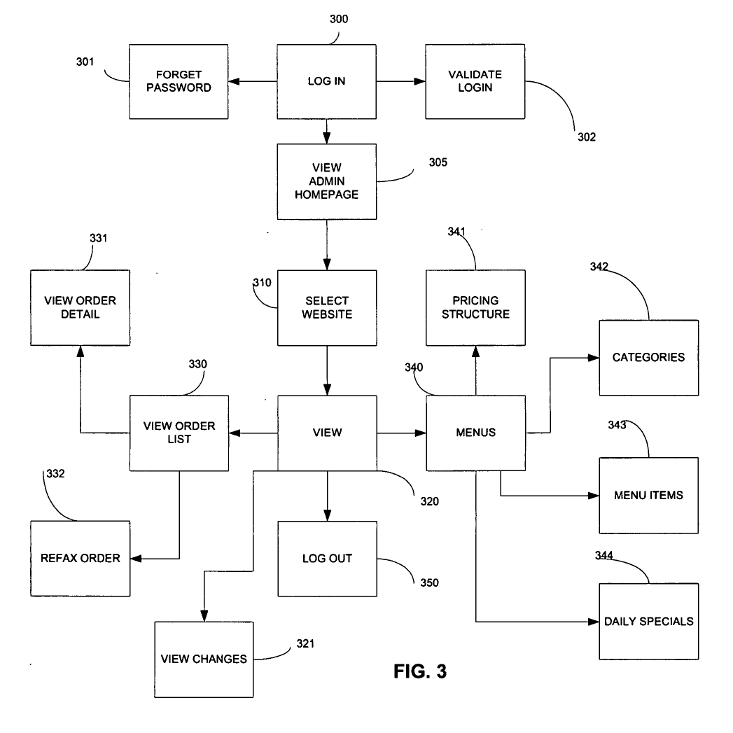

FIG. 3 is a flow diagram of the customer website update of the computer-based method and system for online restaurant ordering according to the present invention. This is the process wherein the restaurant user has a live website as described in FIG. 2 and needs to make updates to the site. For example, the restaurant may have daily specials or add or delete items from its menu. At Step 300, the restaurant user logs into the system administration website using the pre-assigned user id and password. At Step 301, the user may change its password. At Step 302, the user id and password are validated. If the user id and password do not match or are not on file, errors are returned to the user. Otherwise, once the user id and password are validated, at Step 305, the system displays the administration utility home page. The page lists the web page links belonging to the restaurant. At Step 310, the user selects a website and the system presents a view menu of the user's website at Step 320. This window shows customer information, such as company, name, address and telephone number, and the restaurant's website information, such as the website name and URL. At any time, at Step 321, the user can click on the URL for its website to check the changes made. From the main maintenance window, the user has two main paths he or she can take. She can view orders at Step 330 or view menus at Step 340. If the user selects to view orders, at Step 330, the user is presented with a list of all current orders. The user can then view the detail of any order by selecting it at Step 330, and at Step 331, the details of the selected order are displayed. If the order has not been received, at Step 332, the user may want to refax the order. The user may select menus from the main view menu. At Step 340, the menu maintenance screen is presented. At Step 341, the user may add, delete or update the pricing structure. Pricings structures are how the menu items are priced, such as a cup or bowl of soup, small and large salad, etc. At Step 342, the user may add, delete or update menu categories. Menu categories are items such as appetizers, soups and salads, entrees, desserts, etc. At Step 343, the user may update menu items. The user selects the menu item to update and may change the price, the spelling of the item, etc., or add a graphic bullet to the menu item. Menu items may also be added or deleted. At Step 344, the user may update daily specials. When the menus have been updated and the user is satisfied, at Step 350, he or she logs out of the menu maintenance.

It should now be apparent that the above-described web-based restaurant ordering method and system greatly facilitates the take-out ordering process by allowing customers to access a restaurant's own web-site, read an online menu, place an online order (or make dining reservations) by simply by clicking on the desired menu items, verify the order, and submit the order via facsimile to the restaurant, thereby eliminating errors and saving considerable time and frustration. The system actively monitors the order to ensure that no order is lost. The customer can place the order in a few minutes and the order is always correct, and error-free. Moreover, the restaurant receives consistent up-to-date orders from their most current menu, and thus can save money while providing better customer service.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A computer-based method for online restaurant ordering comprising the steps of:
displaying restaurant menu items and prices on a restaurant website devoted to a single restaurant;
allowing a customer to select menu items from said website;
displaying a virtual guest check proximate said displayed menu items and prices and indicating thereon all customer-selected items and associated prices, together with a calculated total price for all customer-selected items on said virtual guest check;
allowing said customer to review, enter delivery information, confirm and submit an order in accordance with the totalized virtual guest check;
automatically sending said submitted order from said website to said restaurant via facsimile transmission; and
sending an email confirmation from said restaurant to said customer confirming receipt of said order.

2. A computer-based method for online restaurant ordering according to claim 1, further comprising a step of displaying ancillary information on said restaurant website inclusive of restaurant location(s), gift certificates, photographs of the restaurant, testimonials of satisfied customers, and information about the restaurant and special events.

3. The computer-based method for online restaurant ordering according to claim 1, further comprising the steps of:
allowing a customer to request a dining reservation from said website;
sending said dining reservation to said restaurant via facsimile; and
confirming said dining reservation via a telephone call from said restaurant to said customer.

4. A computer-based system for online restaurant ordering comprising:
restaurant website templates, wherein said restaurant website templates serves as a basis for allowing individual restaurants to generate their own unique website;
a database to store restaurant demographic and menu data for restaurants, wherein individual restaurant demographic and menu data for a particular restaurant is displayed on the corresponding individual restaurant website;
a menu screen on each individual restaurant website, wherein said menu screen captures menu selections by a customer entered into said restaurant website;
a guest check screen on said website for displaying said selections and totaling process therefore; and
an order submission screen for causing menu selections entered by a customer into said restaurant website are transmitted to the appropriate restaurant via facsimile.

5. A computer-based system for online restaurant ordering according to claim 4 wherein said restaurant website template is a home page template, wherein said home page templates include a plurality of tabs for customer access of restaurant locations, contact information of said restaurant, and hours of operation of said restaurant.

6. A computer-based system for online restaurant ordering according to claim 5 wherein said tabs include a tour tab for displaying photographs of said restaurant.

7. A computer-based system for online restaurant ordering according to claim 5 wherein said tabs include a testimonials tab for displaying testimonials of satisfied customers.

8. A computer-based system for online restaurant ordering according to claim 5 wherein said tabs include an information tab for displaying special events at said restaurant.

9. A computer-based system for online restaurant ordering according to claim 5 wherein said tabs include a reservations tab for allowing customers to make dining reservations online said reservations being transmitted to said restaurant via facsimile.

10. A computer-based system for online restaurant ordering comprising a website displaying a restaurant menu with user-selectable menu items and prices associated with a single restaurant, and a virtual guest check displayed proximate and simultaneous with said menu, said virtual guest check displaying user-selected menu items and prices and a calculated total price for all customer-selected items on said virtual guest check, said website also including controls to allowing said user to review user-selected menu items, prices and totals, enter delivery information, and confirm and submit their order, whereby upon submission said order is automatically sent from said website to said restaurant via facsimile transmission.

11. A computer-based method for updating online restaurant ordering comprising the steps of:
logging into a system administration website using a pre-assigned user id and password;
clicking on a restaurant website URL in a administration utility home page to view restaurant website;
viewing orders in order maintenance view on said restaurant website;
updating said orders in said order maintenance view; and
logging out of said order maintenance view.
